(19) United States
(12) Patent Application Publication
(10) Pub. No.: US 2011/0095597 A1
(43) Pub. Date: Apr. 28, 2011

(54) Tire and Rim

(76) Inventor: Steve Knowles, Scottville, MI (US)

(21) Appl. No.: 12/913,474

(22) Filed: Oct. 27, 2010

Related U.S. Application Data
(60) Provisional application No. 61/255,719, filed on Oct. 28, 2009.

(51) Int. Cl. B60B 3/08; B60B 25/00; B60C 5/00; B60C 25/132

(52) U.S. Cl. 301/64.303; 157/1.17

(57) ABSTRACT

A tire and rim combination includes a pair of circular rims with each of the rims including a radially extending flange member. The flange member can be releasably fit into the perimeter groove of the tire.

### CLAIM FOR PRIORITY

This application claims priority under 35 U.S.C. §119(e) to Provisional U.S. Patent Application No. 61/255,719, filed on Oct. 28, 2009, which is hereby incorporated by reference in its entirety.

### TECHNICAL FIELD

This invention relates to a tire and rim combination. More specifically, the invention relates to a tire and rim combination with an easy mounting mechanism.

### BACKGROUND

The agricultural tire includes tires used on farm vehicles, such as planting or seeding units, tractors and harvesters. The outside diameter of the agricultural tire rim is normally made substantially larger than the tire inside diameter, which can require a great effort to stretch the tire onto the rim. In some cases, the tire needs to be lubed to help it slide on the rim.

### SUMMARY

A tire and rim combination can include an easy mounting mechanism. In one aspect, a tire and rim combination can include a pair of circular rims, a tire, and two center hubs. The hub can be integral with the rim or stamped into the rim. Each of the circular rims can include, in cross-section, a perimeter flange member, a tire seat plane adjacent to perimeter flange member having an outside diameter, and a base plate adjacent and perpendicular to the tire seat plane. The tire can be mounted on the pair of circular rims.

The tire can include a tread portion, a pair of sidewalls terminating in a pair of perimeter grooves on both sides, and a mounting plane adjacent to the pair of grooves having an inside diameter. The perimeter flange member can fit into the grooves for releasably mounting the tire on the circular rims while attaching the circular rims to the sides of the tire respectively. The mounting plane can be adjacent to the tire seat plane after mounting the tire on the rims. Each member of the pair of circular rims can include a center hub on the base plates of the circular rim. Two center hubs can be attached to the base plates of the captive rims respectively.

The perimeter flange member can include a radially extending C-shape cup or V-shape cup. The circular rims can be attached to each other and drawn together to further squeeze the perimeter flange members into the perimeter grooves and hold the tire firmly onto the rims. The circular rims can be attached to each other by bolts. The circular rims can include stamped steel. The center hubs can include stamped steel. The center hubs can be attached to the circular rims by bolts.

The inside diameter of the mounting plane of the tire can be larger than the outside diameter of the tire seat plane of the rims, and the diameter difference is in the range of 0.25 millimeter to 1 millimeter or less than 0.6 millimeter. The grooves of the tire can include an inextensible annular reinforcement embedded therein.

In one aspect, a tire rim can include a pair of circular rims, wherein each member of the pair of circular rims can include, in cross-section, a radially extending C-shape cup flange member, a tire seat plane adjacent to perimeter flange member having an outside diameter, and a base plate adjacent and perpendicular to the tire seat plane. Each member of the pair of circular rims can include a center hub on the base plates of the circular rim. The tire rim can further include two center hubs attached to the base plates of the captive rims respectively. The circular rims can be attached to each other by bolts. The circular rims can include stamped steel.

In another aspect, a method of mounting a tire on a pair of circular rims can include positioning a member of the pair of circular rims into a side of the tire, wherein the tire can include a tread portion, a pair of side portions adjacent to a pair of perimeter grooves on both sides, and a mounting plane adjacent to the pair of grooves having an inside diameter, fitting the C-shape cup flange member into one of the grooves for releasably mounting the tire on the member of the pair of circular rims, turning the tire over, positioning the other member of the pair of circular rims into the other side of the tire, fitting the C-shape cup flange member into the other one of the grooves for releasably mounting the tire on the other member of the pair of circular rims, the tire seat planes of the pair of circular rims adjacent to the mounting plane after mounting the tire on the rims, and using a plurality of bolts to attach and draw the circular rims together to further squeeze the C-shape cup flange members into the perimeter grooves and hold the tire firmly onto the rims.

The method can further include attaching two center hubs to the base plates of the captive rims respectively by bolts.

In another aspect, a method of mounting a tire on a pair of circular rims can include positioning a member of the pair of circular flanges into a perimeter groove of the tire for releasably mounting the member of the pair of circular flanges on the tire, wherein each member of the pair of circular flanges can include, in cross-section, a radially extending flange member and a connection member, and the tire can include a tread portion, a pair of side portions adjacent to a pair of perimeter grooves on both sides, and a mounting plane adjacent to the pair of grooves having an inside diameter, attaching the member of the pair of circular flanges to a member of the pair of circular rims by bolts, wherein each member of the pair of circular rims can include, in cross-section, a tire seat plane having an outside diameter and a base plate adjacent and perpendicular to the tire seat plane, turning the tire over, positioning the other member of the pair of circular flanges into the other one of the pair of perimeter grooves of the tire for releasably mounting the member of the pair of circular flanges on the tire, attaching the other member of the pair of circular flanges to the other member of the pair of circular rims by bolts, the tire seat planes of the pair of circular rims adjacent to the mounting plane after mounting the pair of circular rims on both sides of the tire, and using a plurality of bolts to attach and draw the circular rims together to further squeeze the circular flanges into the pair of perimeter grooves and hold the tire firmly onto the rims.

The method can further include attaching two center hubs to the base plates of the circular rims respectively by bolts. Each member of the pair of circular rims can include a center hub adjacent to the base plate. Each radially extending flange member of the pair of circular flanges can include a radially extending C-shape cup or radially extending V-shape cup.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 depicts an assembly of a tire.

FIG. 2 illustrates an assembled tire.

FIG. 3 illustrates a circular rim.

FIG. 3A illustrates a cross section of the circular rim along line A-A.

FIG. 4 illustrates a side view of the circular rim.

FIG. 5 illustrates a center hub.

FIG. 5A illustrates a cross section of the center hub along line B-B.

FIG. 6 illustrates a side view of the center hub.

FIG. 7 illustrates a tire.

FIG. 8 illustrates a cross section of the tire.

FIG. 8A illustrates a close-in view of part C of the tire shown in FIG. 8.

### DETAILED DESCRIPTION

The outside diameter of an agricultural tire rim is normally made substantially larger than the tire inside diameter, which can require application of significant force to stretch the tire onto the rim. In some cases, the tire needs to be lubed to help it slide on the rim. The rim can be in two halves and get bolted together. After one half is pressed into the tire, the tire needs to be turned over and put the other half on it. Furthermore, before pressing the second half into the tire, a bearing can be placed in the center. When the rims get bolted together, the bearing is captive. After the bearing wears out, the entire rim/tire combination needs to be disassembled to change the bearing. In order to reduce the attendant work of agriculture tire mounting, a tire and rim combination with an easy mounting mechanism is developed.

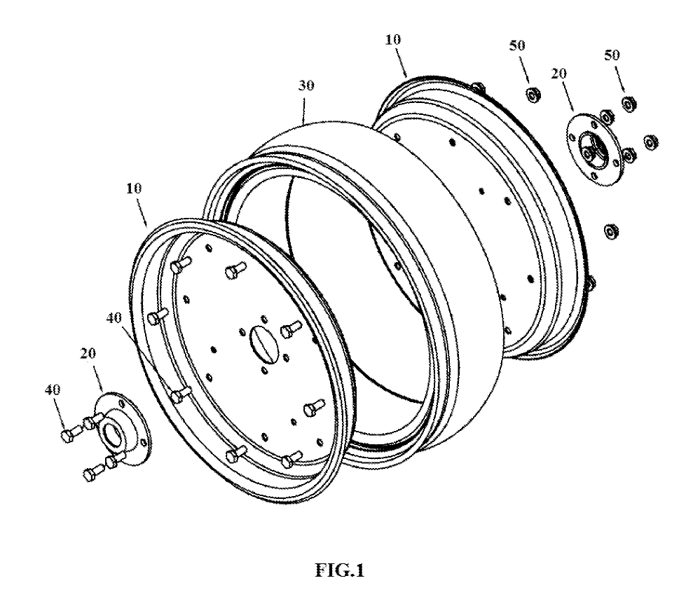

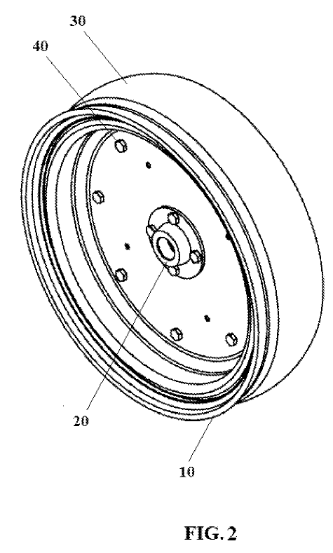

As shown in FIGS. 1 and 2, the easy mounting tire can include a pair of circular rims 10, tire 30, and two center hubs 20. Bolts 40 and nuts 50 can be used to assemble the tire. Removing the bolts holding center hub 20 allows it to be easily removed or replaced. In some embodiments, hub 20 can be an integral part of rim 10 or stamped integral into rim 10.

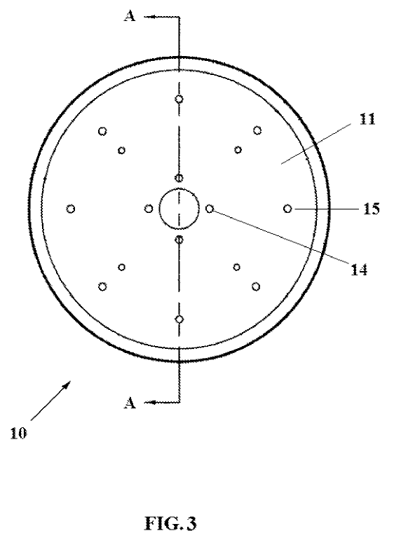

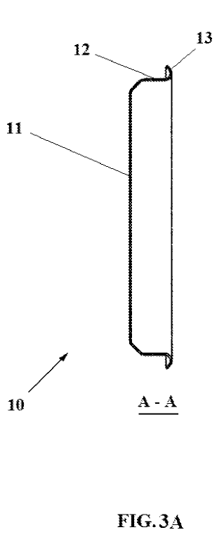

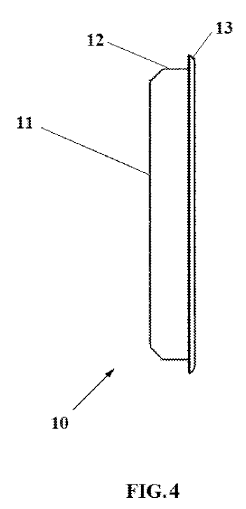

As shown in FIGS. 3, 3A, and 4, circular rim 10 can include, in cross-section, perimeter flange member 13, tire seat plane 12 adjacent to perimeter flange member 13, and base plate 11 adjacent and perpendicular to tire seat plane 12. Base plate 11 can have openings 14 and 15. Openings 14 can be used for bolting center hub 20 onto base plate 11. Openings 15 can be used for bolting the pair of circular rims 10 together. Perimeter flange member 13 can be a radially extending C-shape cup or V-shape cup.

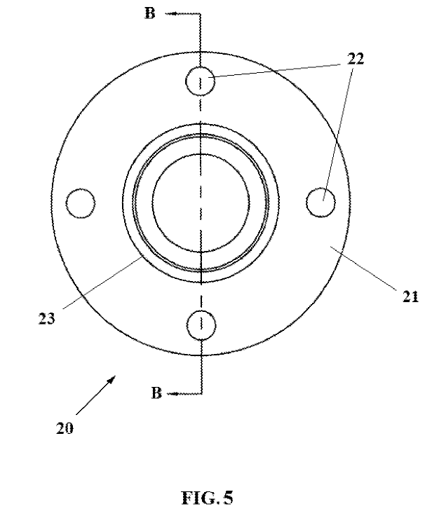

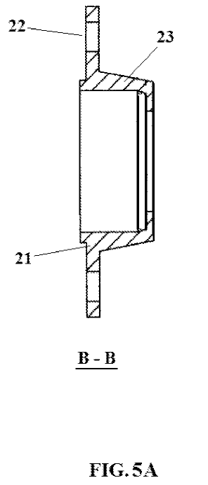

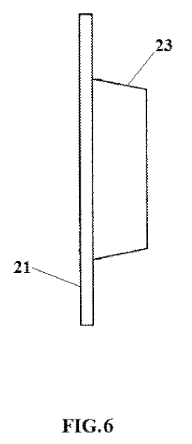

As shown in FIGS. 5, 5A, and 6, center hub 20 can include base plate 21 and extending member 23. Center hub 20 can further include opening 22 to accommodate bolt 40 to fix center hub 20 onto circular rim 10.

In some embodiments, any other suitable hardware connector can be used to fix center hub 20 to circular rims 10. At least one hardware connector (e.g., a screw, nail, rivet, weld, adhesive, or braze joint) is positioned within each opening 22 to fix center hub 20 onto circular rim 10.

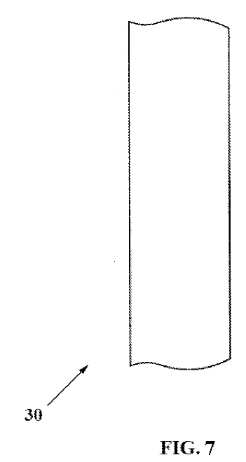

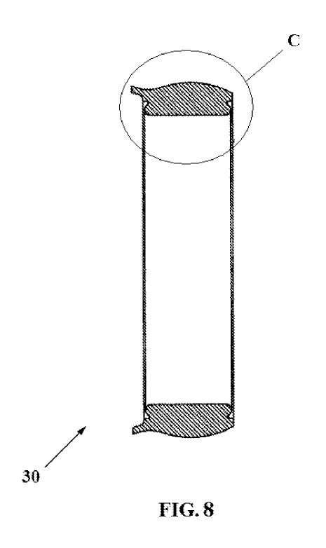

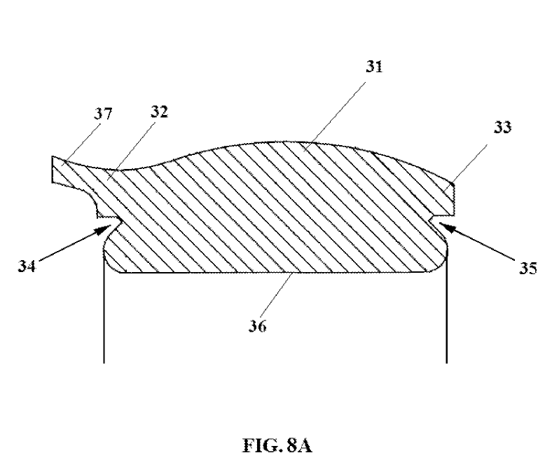

As shown in FIGS. 7, 8, and 8A, tire 30 can include tread portion 31, a pair of side portions 32 and 33, a pair of perimeter grooves 34 and 35 on both sides, and mounting plane 36. Perimeter flange member 13 can fit into the grooves for releasably mounting tire 30 on circular rims 10 while attaching circular rims 10 to the sides of tire 30 respectively. Tire 30 can further include portion 37 extending from side portion 32.

A hardware connector can be used to attach and draw circular rims 10 together to further squeeze perimeter flange members 13 into perimeter grooves 34 and 35 and hold tire 30 firmly onto rims 10. At least one hardware connector (e.g., a screw, nail, rivet, weld, adhesive, or braze joint) is positioned within each opening (14 in FIG. 3) to fix circular rims 10 together. In some embodiment, the hardware connector can be bolts 40 and nuts 50. In some embodiment, as the bolts are tightened, it can draw the rims together by about 2.5 millimeter and squeezes perimeter flange members 13 into the groove, thus compressing and holding the tire firmly onto the rim. Each side of tire 30 is compressed by about 1.25 millimeter, thus being held firmly by rims 10 and is physically captive and can not get off rims 10. Perimeter flange members 13 captivates tire 30 on rims 10 and prevents it physically from coming off, and the compression keeps tire 30 from rotating on rims 10 because of the force of compression and friction. In some embodiment, tires 30 can be slightly larger than rims 10 so that rims 10 can slip fit into tires 30, with no pressing being required.

The mounting plane of the tire can have an inside diameter, and the tire seat plane of the rims can have an outside diameter. In some embodiments, the inside diameter of the mounting plane can be larger than the outside diameter of the tire seat plane of the rims, and the diameter difference can be in the range of 0.25 millimeter to 1 millimeter or less than 0.6 millimeter. Therefore, the assembly and disassembly of the tire and rim can be done with ease.

To securing tire 30 onto circular rims 10, grooves 34 and 35 can further include an inextensible annular reinforcement embedded therein. The reinforcement can include a fabric (e.g., a cross-woven, knitted, or nylon.)

In some embodiments, a method of mounting a tire on a pair of circular rims can include pressing a member of the pair of circular rims into a side of the tire. The tire can include a tread portion, a pair of side portions adjacent to a pair of perimeter grooves on both sides, and a mounting plane adjacent to the pair of grooves having an inside diameter.

The method can further include fitting the C-shape cup flange member (13 in FIG. 3A) into one of the grooves (34 and 35 in FIG. 8A) for releasably mounting the tire on the member of the pair of circular rims, turning the tire over, pressing the other member of the pair of circular rims into the other side of the tire, fitting the C-shape cup flange member into the other one of the grooves for releasably mounting the tire on the other member of the pair of circular rims, the tire seat planes (12 in FIG. 3A) of the pair of circular rims adjacent to the mounting plane (36 in FIG. 8A) after mounting the tire on the rims, and using a plurality of bolts (40 in FIG. 1) to attach and draw the circular rims together to further squeeze the C-shape cup flange members into the perimeter grooves and hold the tire firmly onto the rims.

The method can further include attaching two center hubs (20 in FIG. 1) to the base plates (11 in FIG. 3A) of the captive rims respectively by bolts. In some embodiments, the hub (20 in FIG. 1) can be an integral part of the rim (20 in FIG. 1).

In some embodiments, a method of mounting a tire on a pair of circular rims can include pressing a member of the pair of circular flanges into a perimeter groove of the tire for releasably mounting the member of the pair of circular flanges on the tire, wherein each member of the pair of circular flanges can include, in cross-section, a radially extending flange member and a connection member, and the tire can include a tread portion, a pair of side portions adjacent to a pair of perimeter grooves on both sides, and a mounting plane adjacent to the pair of grooves having an inside diameter.

The method can further include attaching the member of the pair of circular flanges to a member of the pair of circular rims by bolts, wherein each member of the pair of circular rims can include, in cross-section, a tire seat plane having an outside diameter and a base plate adjacent and perpendicular to the tire seat plane.

The method can further include turning the tire over, pressing the other member of the pair of circular flanges into the other one of the pair of perimeter grooves of the tire for releasably mounting the member of the pair of circular flanges on the tire, attaching the other member of the pair of circular flanges to the other member of the pair of circular rims by bolts, the tire seat planes of the pair of circular rims adjacent to the mounting plane after mounting the pair of circular rims on both sides of the tire, and using a plurality of bolts to attach and draw the circular rims together to further squeeze the circular flanges into the pair of perimeter grooves and hold the tire firmly onto the rims.

The method can further include attaching two center hubs to the base plates of the circular rims respectively by bolts. Each member of the pair of circular rims can include a center hub adjacent to the base plate. Each radially extending flange member of the pair of circular flanges can include a radially extending C-shape cup or radially extending V-shape cup.

While the invention has been shown and explained in the embodiment described herein, it is to be understood that the invention should not be confined to the exact showing of the drawings, and that any variations, substitutions, and modifications are intended to be comprehended within the spirit of the invention. Other embodiments are within the claims.

What is claimed is:

1. A tire and rim combination, comprising:
a pair of circular rims, wherein each member of the pair of circular rims comprises, in cross-section, a perimeter flange member, a tire seat plane adjacent to perimeter flange member having an outside diameter, and a base plate adjacent and perpendicular to the tire seat plane; and
a tire mounted on the pair of circular rims, wherein the tire comprises a tread portion, a pair of sidewalls terminating in a pair of perimeter grooves on both sides, the perimeter flange member fitting into the grooves for releasably mounting the tire on the circular rims while attaching the circular rims to the sides of the tire respectively, and a mounting plane adjacent to the pair of grooves having an inside diameter, the mounting plane adjacent to the tire seat plane after mounting the tire on the rims.

2. The tire and rim combination of claim 1, wherein each member of the pair of circular rims comprises a center hub on the base plates of the circular rim.

3. The tire and rim combination of claim 1, further comprising two center hubs attached to the base plates of the circular rims respectively.

4. The tire and rim combination of claim 1, wherein the perimeter flange member comprises a radially extending C-shape cup.

5. The tire and rim combination of claim 1, wherein the perimeter flange member comprises a radially extending V-shape cup.

6. The tire and rim combination of claim 1, wherein the circular rims are attached to each other and drawn together to further squeeze the perimeter flange members into the perimeter grooves and hold the tire firmly onto the rims.

7. The tire and rim combination of claim 4, wherein the circular rims are attached to each other by bolts.

8. The tire and rim combination of claim 1, wherein the circular rims comprise stamped steel.

9. The tire and rim combination of claim 2, wherein the center hubs comprise stamped steel.

10. The tire and rim combination of claim 3, wherein the center hubs are attached to the circular rims by bolts.

11. The tire and rim combination of claim 1, wherein the inside diameter of the mounting plane of the tire is larger than the outside diameter of the tire seat plane of the rims, and the diameter difference is in the range of 0.25 millimeter to 1 millimeter.

12. The tire and rim combination of claim 1, wherein the inside diameter of the mounting plane of the tire is larger than the outside diameter of the tire seat plane of the rims, and the diameter difference is less than 0.6 millimeter.

13. The tire and rim combination of claim 1, wherein the grooves of the tire have an inextensible annular reinforcement embedded therein.

14. A tire rim, comprising:
a pair of circular rims, wherein each member of the pair of circular rims comprises, in cross-section, a radially extending C-shape cup flange member, a tire seat plane adjacent to C-shape cup flange member having an outside diameter, and a base plate adjacent and perpendicular to the tire seat plane.

15. The tire rim of claim 14, wherein each member of the pair of circular rims comprises a center hub on the base plates of the circular rim.

16. The tire rim of claim 14, further comprising two center hubs attached to the base plates of the captive rims respectively.

17. The tire rim of claim 14, wherein the circular rims are attached to each other by bolts.

18. The tire rim of claim 14, wherein the circular rims comprise stamped steel.

19. A method of mounting a tire on a pair of circular rims, comprising:
positioning a member of the pair of circular rims into a side of the tire, wherein each member of the pair of circular rims comprises, in cross-section, a radially extending C-shape cup flange member, a tire seat plane adjacent to C-shape cup flange member having an outside diameter, and a base plate adjacent and perpendicular to the tire seat plane, and the tire comprises a tread portion, a pair of side portions adjacent to a pair of perimeter grooves on both sides, and a mounting plane adjacent to the pair of grooves having an inside diameter;
fitting the C-shape cup flange member into one of the grooves for releasably mounting the tire on the member of the pair of circular rims;
turning the tire over;
positioning the other member of the pair of circular rims into the other side of the tire;
fitting the C-shape cup flange member into the other one of the grooves for releasably mounting the tire on the other member of the pair of circular rims, the tire seat planes of the pair of circular rims adjacent to the mounting plane after mounting the tire on the rims; and
using a plurality of bolts to attach and draw the circular rims together to further squeeze the C-shape cup flange members into the perimeter grooves and hold the tire firmly onto the rims.

20. The method of claim 19, further comprising attaching two center hubs to the base plates of the circular rims respectively by bolts.

21. The method of claim 19, wherein each member of the pair of circular rims comprises a center hub on the base plates of the circular rim.

22. The method of claim 19, wherein the inside diameter of the mounting plane of the tire is larger than the outside diameter of the tire seat plane of the rims, and the diameter difference is in the range of 0.25 millimeter to 1 millimeter.

23. The method of claim 19, wherein the inside diameter of the mounting plane of the tire is larger than the outside diameter of the tire seat plane of the rims, and the diameter difference is less than 0.6 millimeter.

24. The method of claim 19, wherein the circular rims comprise stamped steel.

25. A method of mounting a tire on a pair of circular rims, comprising:
positioning a member of the pair of circular flanges into a perimeter groove of the tire for releasably mounting the member of the pair of circular flanges on the tire, wherein each member of the pair of circular flanges comprises, in cross-section, a radially extending flange member and a connection member, and the tire comprises a tread portion, a pair of side portions adjacent to a pair of perimeter grooves on both sides, and a mounting plane adjacent to the pair of grooves having an inside diameter;
attaching the member of the pair of circular flanges to a member of the pair of circular rims by bolts, wherein each member of the pair of circular rims comprises, in cross-section, a tire seat plane having an outside diameter and a base plate adjacent and perpendicular to the tire seat plane;
turning the tire over;
positioning the other member of the pair of circular flanges into the other one of the pair of perimeter grooves of the tire for releasably mounting the member of the pair of circular flanges on the tire;
attaching the other member of the pair of circular flanges to the other member of the pair of circular rims by bolts, the tire seat planes of the pair of circular rims adjacent to the mounting plane after mounting the pair of circular rims on both sides of the tire; and
using a plurality of bolts to attach and draw the circular rims together to further squeeze the circular flanges into the pair of perimeter grooves and hold the tire firmly onto the rims.

26. The method of claim 25, further comprising attaching two center hubs to the base plates of the circular rims respectively by bolts.

27. The method of claim 25, wherein each member of the pair of circular rims comprises a center hub adjacent to the base plate.

28. The method of claim 25, wherein each radially extending flange member of the pair of circular flanges comprises a radially extending C-shape cup.

29. The method of claim 25, wherein each radially extending flange member of the pair of circular flanges comprises a radially extending V-shape cup.

30. The method of claim 25, wherein the inside diameter of the mounting plane of the tire is larger than the outside diameter of the tire seat plane of the rims, and the diameter difference is in the range of 0.25 millimeter to 1 millimeter.

31. The method of claim 25, wherein the inside diameter of the mounting plane of the tire is larger than the outside diameter of the tire seat plane of the rims, and the diameter difference is less than 0.6 millimeter.

32. The method of claim 25, wherein the circular rims comprise stamped steel.
